(19) United States
(12) Patent Application Publication
(10) Pub. No.: US 2026/0197641 A1
(43) Pub. Date: Jul. 9, 2026

(54) Methods and Devices for Wake-Up Signaling of Wireless Devices

(71) Applicant: Telefonaktiebolaget LM Ericsson (publ), Stockholm (SE)

(72) Inventors: Bipin Balakrishnan, Lund (SE); Fredrik Dahlgren, Lund (SE); Gang Zou, Lund (SE); Saeed Bastani, Dalby (SE)

(21) Appl. No.: 19/135,518

(22) PCT Filed: Dec. 21, 2022
(86) PCT No.: PCT/EP2022/087295

§ 371 Date: Jun. 4, 2025

(51) Int. Cl. H04W 12/06; G06F 9/4401

(52) U.S. Cl. CPC H04W 12/06; G06F 9/4418

(57) ABSTRACT

The present disclosure relates to a method performed in a wireless device. The method comprises: receiving (S102) a wake-up signal from a radio node, wherein the wake-up signal comprises an authentication pattern; determining (S106) whether or not the authentication pattern matches a verification pattern of the wireless device, wherein the verification pattern is determined according to a configured set of rules; in response to the authentication pattern matching the verification pattern: performing (S112) a wake-up process of the wireless device, and transmitting (S114) an acknowledgement signal to the radio node. The present disclosure further relates to a method performed in a radio node, as well as a wireless device and a radio node.

### TECHNICAL FIELD

The present disclosure relates to the field of wireless communications, and in particular to wake-up signaling of wireless devices.

### BACKGROUND

In the more and more digitalized world, wireless devices have become more widely used in old and new applications. Connected vehicles, more capable smart phones, and Internet-of-Things (IoT) enabled devices are just some examples of such applications. Within this field, improved performance and reduced energy consumption are two aspects that are constantly sought after, especially in enabling wireless communication in IoT or Machine Type Communication (MTC) applications.

Wake-up signaling is one technology that has been proposed to improve these devices. The device can go into deep sleep when it is not needed, in order to conserve power. A base station can then wake up the devices when needed, e.g., by transmitting a wake-up signal to the device. As an example, 3^{rd} Generation Partnership Project (3GPP) Long Terms Evolution (LTE) cellular network uses a wake-up signal (WUS) to wake up IoT-enabled user equipments (UEs). The wake-up signal is transmitted from a base station to a UE which is in idle mode (e.g., deep sleep) and required to decode the physical downlink control channel in paging occasions, as described in 3GPP, Evolved Universal Terrestrial Radio Access (E-UTRA); Physical channels and modulation, Release 15, 2018. In those cases, the UE needs wake up to perform time/frequency synchronization, receive/decode WUS and further receive/decode the followed paging information if it finds the WUS is targeting itself. As the distance between the base station and the IoT UE is generally long, the WUS is often transmitted with certain radio frequency (RF) bandwidth and/or encoded in time or frequency domain to lower its miss-detection rate.

For ultra-low-power IoT devices, e.g., wireless sensors, placing relay nodes is one approach to extend cellular network coverage over them. For instance, X. Cheng, et al proposes in “Relay Sensor Placement in Wireless Sensor Networks”, a solution to place relay nodes in a wireless sensor network. All the wireless sensors can be connected to the relay nodes which are more powerful and able to transfer data over long distance.

In general, prior art in the field of wake-up signaling of devices have focused on power-efficient implementations as well as ways of utilizing selective signaling to target either individual devices or groups of devices. However, there is still a need for improvements of wake-up signaling.

### SUMMARY

The herein disclosed technology seeks to mitigate, alleviate, or eliminate one or more deficiencies and disadvantages in the prior art singly or in any combination.

The inventors have realized that, since there is a risk of unintentional or malicious wake-up signals causing the wireless device to wake up to process the wake-up signal, an authentication/verification process can be implemented to mitigate this risk. Maliciously sent wake-up signals in particular, may be used as a tool for causing loss of power of the wireless device, or rendering the wireless device temporarily useless (e.g., through Denial-of-Service attacks). This may be avoided, or at least reduced, by some embodiments of the present disclosure. In addition, as disclosed herein, the wireless device need not send any response signals to an unauthorized radio node sending such malicious wake-up signal, thereby maintaining a stealth mode. Some embodiments of the present disclosure hence contribute to a more secure and robust way for wake-up signaling.

When it comes to unintended wake-up signals, especially when the wake-up signal is broadcasted at a group level, there is a risk of unnecessarily waking up an unintended wireless device. Some embodiments provide improved robustness in terms of this aspect as well.

Various aspects and embodiments of the present disclosure or the technology disclosed herein are defined below and in the accompanying independent and dependent claims.

According to a first aspect of the present disclosure, there is provided a method performed in a wireless device. The method may be a method for waking up the wireless device. In other words, the method may be suitable for transforming the wireless device from a first operating mode to a second operating mode. The method comprises receiving a wake-up signal from a radio node, wherein the wake-up signal comprises an authentication pattern. Further, the method comprises determining whether or not the authentication pattern matches a verification pattern of the wireless device, wherein the verification pattern is determined according to a configured set of rules. Further, the method comprises, in response to the authentication pattern matching the verification pattern, performing a wake-up process of the wireless device. Further, the method comprises transmitting an acknowledgement signal to the radio node.

As mentioned above, an advantage of the proposed method is that authentication process (also referred to as the verification process), which throughout the present disclosure is used to refer to any steps relating to verification of the wake-up signal (or any subsequent signals), facilitates a more secure and robust wake-up signaling, in which a number of unnecessary wake-ups of the wireless device can be reduced.

According to a second aspect of the present disclosure, there is provided a computer program, comprising instructions which, when executed on at least one processor, cause the at least one processor to carry out the method according to any one of the embodiments of the first aspect. With this second aspect of the disclosed technology, similar advantages and preferred features are present as in the other aspects. In order to avoid undue repetition, reference is made to the above.

According to a third aspect of the present disclosure, there is provided a (non-transitory) computer-readable storage medium storing one or more programs configured to be executed by one or more processors of a processing device, the one or more programs comprising instructions for performing the method according to any one of the embodiments of the first aspect. With this third aspect of the disclosed technology, similar advantages and preferred features are present as in the other aspects. In order to avoid undue repetition, reference is made to the above.

The term “non-transitory,” as used herein, is intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link. Thus, the term “non-transitory”, as used herein, is a limitation of the medium itself (i.e., tangible, not a signal) as opposed to a limitation on data storage persistency (e.g., RAM vs. ROM).

According to a fourth aspect of the present disclosure, there is provided a wireless device. The wireless device comprises control circuitry. The control circuitry is configured to receive a wake-up signal from a radio node, wherein the wake-up signal comprises an authentication pattern. The control circuit is further configured to determine whether or not the authentication pattern matches a verification pattern of the wireless device, wherein the verification pattern is determined according to a configured set of rules. The control circuitry is further configured to, in response to the authentication pattern matching the verification pattern, perform a wake-up process of the wireless device. The control circuitry is further configured to transmit an acknowledgement signal to the radio node. With this fourth aspect of the disclosed technology, similar advantages and preferred features are present as in the other aspects. In order to avoid undue repetition, reference is made to the above.

According to a fifth aspect of the present disclosure, there is provided a method performed in a radio node. The method may be a method for waking up a wireless device. In other words, the method may be suitable for causing the wireless device to transform from a first operating mode to a second operating mode. The method comprises obtaining an authentication pattern determined according to a configured set of rules for a wireless device. Further, the method comprises transmitting a wake-up signal to the wireless device, wherein the wake-up signal comprises the authentication pattern. Further the method comprises receiving an acknowledgement signal from the wireless device, in response to the authentication pattern matching a verification pattern of the wireless device. With this fifth aspect of the disclosed technology, similar advantages and preferred features are present as in the other aspects. In order to avoid undue repetition, reference is made to the above.

According to a sixth aspect of the present disclosure, there is provided a computer program, comprising instructions which, when executed on at least one processor, cause the at least one processor to carry out the method according to any one of the embodiments of the fifth aspect. With this sixth aspect of the disclosed technology, similar advantages and preferred features are present as in the other aspects. In order to avoid undue repetition, reference is made to the above.

According to a seventh aspect of the present disclosure, there is provided a (non-transitory) computer-readable storage medium storing one or more programs configured to be executed by one or more processors of a processing device, the one or more programs comprising instructions for performing the method according to the any one of the embodiments of fifth aspect. With this seventh aspect of the disclosed technology, similar advantages and preferred features are present as in the other aspects. In order to avoid undue repetition, reference is made to the above.

According to an eighth aspect of the present disclosure, there is provided a radio node. The radio node comprises control circuitry. The control circuitry is configured to obtain an authentication pattern determined according to a configured set of rules for a wireless device. The control circuitry is further configured to transmit a wake-up signal to the wireless device, wherein the wake-up signal comprises the authentication pattern. The control circuitry is further configured to receive an acknowledgement signal from the wireless device, in response to the authentication pattern matching a verification pattern of the wireless device. With this eighth aspect of the disclosed technology, similar advantages and preferred features are present as in the other aspects. In order to avoid undue repetition, reference is made to the above.

The disclosed aspects and preferred embodiments may be suitably combined with each other in any manner apparent to anyone of ordinary skill in the art, such that one or more features or embodiments disclosed in relation to one aspect may also be considered to be disclosed in relation to another aspect or embodiment of another aspect.

Further embodiments of the disclosure are defined in the dependent claims. It should be emphasized that the term “comprises/comprising” when used in this specification is taken to specify the presence of stated features, integers, steps, or components. It does not preclude the presence or addition of one or more other features, integers, steps, components, or groups thereof. As used herein, the singular forms “a”, “an” and “the” are intended to include the plural forms as well, unless the context clearly indicates otherwise.

A possible associated advantage of the proposed solution is that the verification process (i.e. the comparison between the authentication pattern and the verification pattern) may be performed in an energy efficient way. Thus, the hardware requirements of the circuitry used by the wireless device to perform the process is low. In particular, the proposed solution can be performed in in an always-on domain of the wireless device, and can work on low frequency sleep clock of typical wireless device implementations.

A further possible advantage of the proposed solution is that it can be easily complemented with additional security mechanisms, and possibly at different power consumption costs.

A further possible advantage of the proposed solution is to discard any maliciously sent wake-up signals (that are received by the wireless device) to prevent energy waste in the wireless device. This comes from the fact that the wake-up signal first has to be verified (e.g., by a low-power circuit), before any wake-up process is performed. If not verified, the wireless device can simply continue in sleep mode.

A further possible advantage of the proposed solution is that group-based wake-up signaling (i.e., broadcasting of the wake-up signal) has little to no effect on the energy consumption of unintended wireless devices, for similar reasons as malicious wake-up signals.

A further possible advantage of the proposed solution is that the wireless device can be in stealth mode (i.e., no paging or signal exchange during an initial part of the wake-up signaling process) for any non-authorized radio nodes.

These and other features and advantages of the present disclosure will in the following be further clarified with reference to the embodiments described hereinafter.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments. In the drawings:

FIG. 1 is a flowchart illustrating some embodiments of a method performed in a wireless device.

FIG. 2 is a flowchart illustrating some embodiments of a method performed in a radio node.

FIG. 3 is a schematic illustration of a wireless device according to some embodiments.

FIG. 4 is a schematic illustration of a radio node according to some embodiments.

FIGS. 5A and 5B are block diagrams of some example configurations of a wireless device according to some embodiments.

FIGS. 6, 7 and 8 are signaling diagrams illustrating an exchange of signals according to some embodiments.

FIG. 9 is a flowchart illustrating some embodiments of a method performed in a wireless device.

### DETAILED DESCRIPTION

The present disclosure is described below with reference to the accompanying drawings, in which certain aspects of the present disclosure are shown. The present disclosure may, however, be embodied in many different forms and should not be construed as limited to the embodiments and aspects set forth herein; rather, these embodiments are provided by way of example so that this disclosure will be thorough and complete, and will fully convey the scope of the present disclosure to those skilled in the art. Like numbers refer to like elements throughout the description.

It is to be understood that the present disclosure is not limited to the embodiments described herein and illustrated in the drawings; rather, those skilled in the art will recognize that many changes and modifications may be made within the scope of the appended claims

For example, those skilled in the art will appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

The term “radio node” used herein can be any kind of radio node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, integrated access and backhaul (IAB) node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The radio node may also comprise test equipment. The term “radio node” used herein may be used to also denote a wireless device (WD). Moreover, a radio node may also be in the form of a sub-entity of a BTS, such as e.g. a Centralized Unit (CU) or a Distributed Unit (DU).

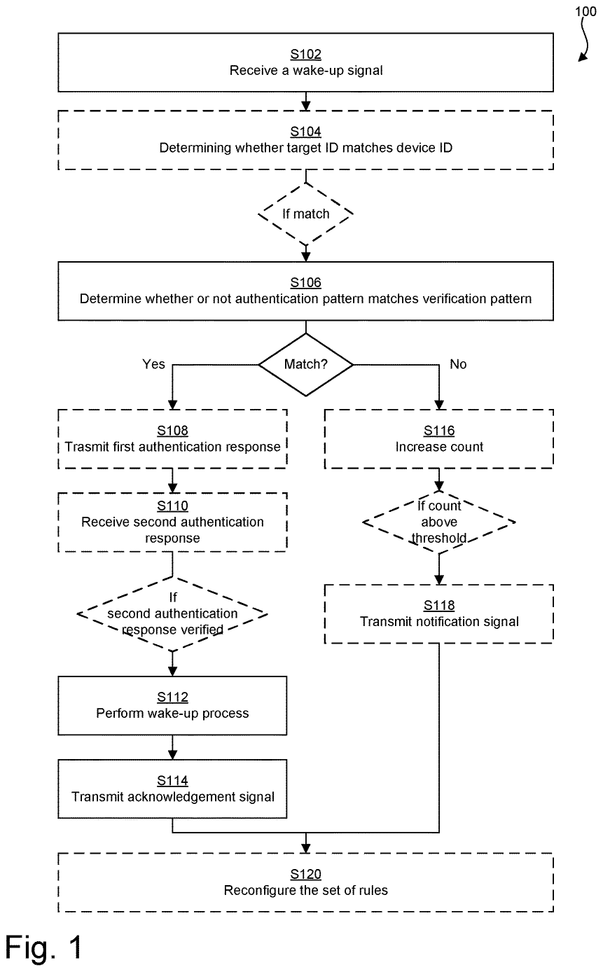

Hereinafter, various techniques for wake-up signaling will be described with reference to FIG. 1 to 9, in which a method performed in a wireless device and a wireless device thereof, as well as a method performed in a radio node and a radio node thereof is presented.

FIG. 1 is a flowchart illustrating some embodiments of a method 100 performed in a wireless device. It should be appreciated that the method 100 of FIG. 1 comprises some steps which are illustrated as boxes in solid lines and some steps which are illustrated in dashed lines. The steps which are shown in solid lines are steps which are comprised in the broadest example embodiment of the method 100. The steps which are comprised in dashed lines are examples of a number of optional steps which may form part of a number of alternative embodiments. It should be appreciated that the optional steps need not be performed in order. Furthermore, it should be appreciated that not all of the steps need to be performed. The example steps may be performed in any order and in any combination.

In more detail, the presently disclosed method 100 may be seen as a method for transforming the wireless device from a first operating mode (e.g. a sleep or idle mode) to a second operating mode (e.g. an active mode). In particular, the various techniques described herein are based on the finding that an authentication process may be used to improve the wake-up process. It should be noted that the techniques of the present disclosure may be applicable in various fields. However, the techniques are particularly useful in applications where data is communicated less frequently, such as a few times per day, per week or per month, etc. The remainder of the time, the wireless device can be kept in an idle or low power mode to e.g. conserve power or prolong a lifetime of the wireless device. In other words, a base station (BS) that transmits the wake-up signal, only has to wake up the wireless device when it is needed.

The wireless device (may also, in this disclosure, be referred to as a user equipment (UE), a terminal, or a client) is, throughout the present disclosure, to be understood as a non-limiting term meaning any device or node capable of receiving in downlink (DL) and transmitting in uplink (UL) (e.g. PDA, laptop, mobile, sensor, fixed relay, mobile relay, or even a radio base station (e.g. a femto base station) etc.). The term UE, as used herein, also encompasses Internet of Things (IoT) devices such as smart sensors, smart appliances, etc.

In some embodiments, the non-limiting terms wireless device (WD) or a user equipment (UE) are used interchangeably. The WD herein can be any type of wireless device capable of communicating with a network node or another WD over radio signals. The WD may be a user device. The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

It should be noted that the term wireless device, or in particular, the term user equipment (UE) may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE may be any UE identified by the 3rd Generation Partnership Project (3GPP), including a NB-IoT UE, a machine type communication (MTC) UE, and/or an enhanced MTC (eMTC) UE.

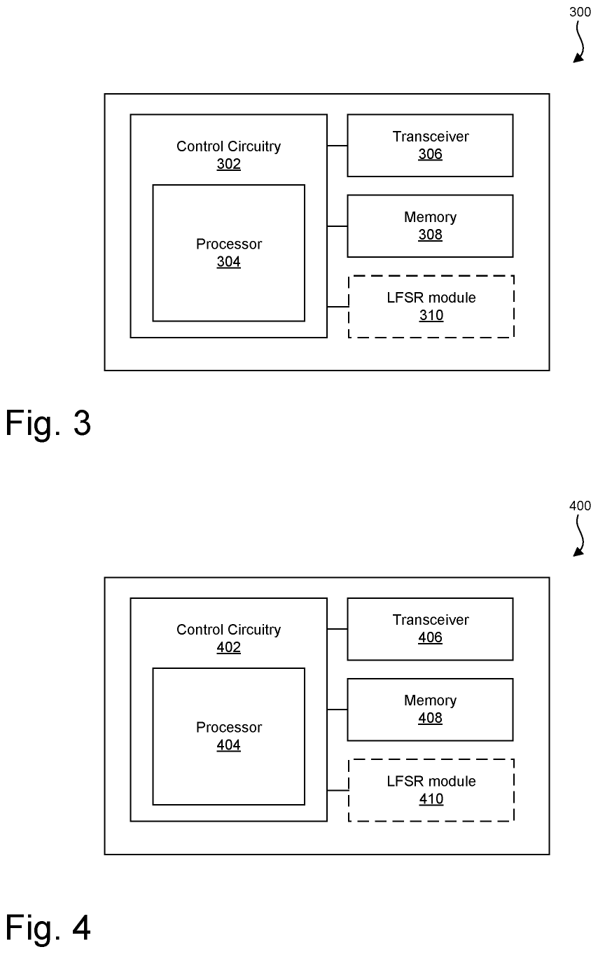

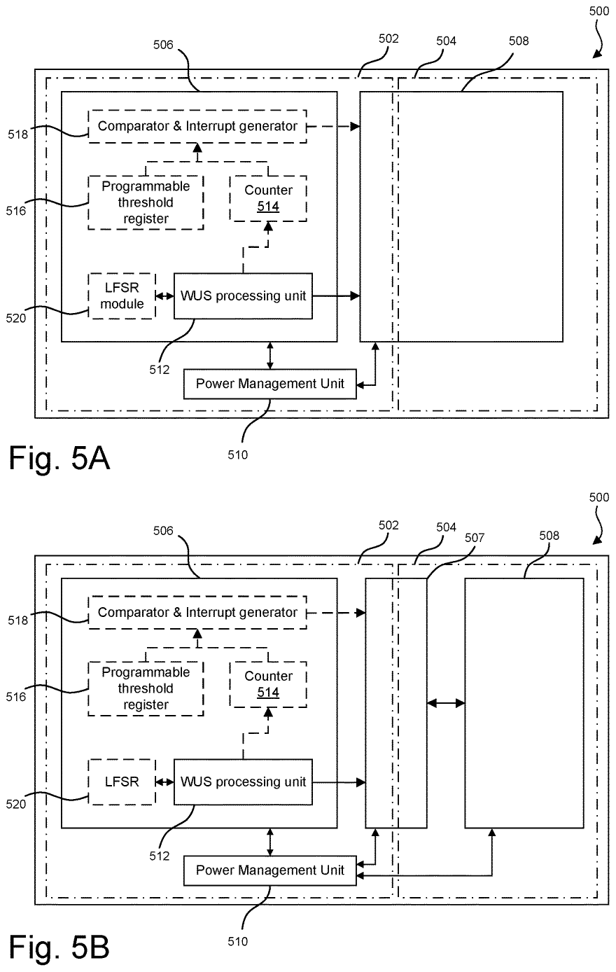

A wireless device according to some embodiments of the present disclosure is further described in connection with FIGS. 3, 5A and 5B below.

Note that although terminology from one particular wireless system, such as, for example, 3GPP LTE may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB), Global System for Mobile Communications (GSM), 5G/New Radio (NR), 6G and/or any future wireless system may also benefit from exploiting the ideas covered within this disclosure.

In the following, the different steps are described in more detail with reference to FIG. 1. Even though illustrated in a specific order, the steps of the method 100 (both the steps illustrated in solid lines and in dashed lines) may be performed in any suitable order, in parallel, partially in parallel, as well as multiple times.

The method comprises receiving S102 a wake-up signal from a radio node. The radio node may be a radio base station (BS). Thus, the wake-up signal may be transmitted by a direct link. Put differently, the direct link may enable direct reception of the wake-up signal sent by the BS. Thereby there is no need for any relaying nodes. Alternatively, the radio node may be a relay node. The relay node may be a further wireless device used to relay messages from a BS to the intended wireless device. Thus, the communication between the radio node and the wireless device may be performed by any suitable device-to-device communication protocol as is readily understood by a person skilled in the art. The wake-up signal may be transmitted by a relay link through one or more relay nodes, thereby extending the transmission link. Either a single-hop or multi-hop relaying link may be used to transmit the wake-up signal from the BS to the wireless device. For example, for 3GPP Long Term Evolution (LTE) communication system, it is known to utilize a relay-based connection between a remote node (e.g. the wireless device) and a BS.

The wake-up signal comprises an authentication pattern. The authentication pattern is to be understood as an authentication key of the wake-up signal, which allows the wireless device to verify the authenticity of the wake-up signal before acting on it. Thus, wake-up signals that may have been sent erroneously, or by malicious intent, can be prevented from waking up the wireless device. The authentication pattern may for instance comprise a sequence of numbers or characters. The wake-up signal may further comprise additional data typically used in wake-up signals.

Moving on, the method 100 further comprises determining S106 whether or not the authentication pattern matches a verification pattern of the wireless device. Put differently, the verification pattern, which may be stored on, or determined by, the wireless device is compared to the authentication pattern. The verification pattern is determined according to a configured set of rules. Thus, the verification pattern may be determined on demand by the wireless device, e.g. in response to receiving the authentication pattern. In some embodiments, the authentication pattern is determined according to the same set of rules as the verification pattern. The set of rules of the wireless device may be configured at a point in time prior to the wake-up signal being received S102. Put differently, the set of rules for determining the verification pattern (and the authentication pattern) may be agreed upon (i.e. configured) by the wireless device and the radio node beforehand. As an example, the set of rules may be configured at a time of a first power on of the wireless device. Alternatively, the set of rules may be configured at a time when the wireless device first connects to a network (or to the BS). In such cases, the set of rules may be communicated between the radio node and the wireless device. Further, the set of rules may be unique to the wireless device. This may allow the process of verifying the authentication pattern (i.e. by determining whether the authentication pattern matches the verification pattern) to also function as a selector of which wireless device to be targeted. As an example, in case several wireless devices are present in a network, each wireless device may have a differently configured set of rules. A wake-up signal may then be broadcast by the BS without a risk of waking up any unintended wireless devices. Alternatively, the set of rules may be the same for a group of wireless devices, or for a category for wireless devices. The category of a wireless device may e.g. be defined by an application running on the wireless device.

Optionally, the method may further comprise reconfiguring S120 the set of rules. Reconfiguring the set of rules may comprise resetting or changing one or more rules of the set of rules. Reconfiguring S120 the set of rules may comprise transmitting an indication of a request for an updated set of rules to the radio node. Alternatively, or additionally, reconfiguring S120 the set of rules may comprise receiving an updated set of rules from the radio node. Reconfiguring the set of rules may be advantageous in that it may improve security, e.g. in the sense that the risk of a third party figuring out the set of rules may be reduced. It may further serve the purpose of ensuring reliability, e.g. in the sense that it may reduce the risk of the wireless device and the radio node getting out of sync. Reconfiguring S120 the set of rules may either be performed periodically or when needed. As an example, the set of rules may be reconfigured S120 at a time interval. The time interval may be a predetermined time interval. For example, the set of rules may be reconfigured every once a day, week, or month etc. As another example, the set of rules may be reconfigured S120 in response to an event occurring. An event may for instance be that a number of failed verification attempts exceed a threshold (as is further described below), or that an error occurs when the authentication pattern is determined (e.g., by the radio node) or when the wireless device determines the verification pattern. As a further example, the event may be that a certain amount of successful verification attempts has been performed. In other words, the set of rules may be reconfigured after a certain amount of wake-ups have been performed. As a further example, the event may be that the authentication pattern has reached an end of a pre-defined sequence. The set of rules may then be reset to its starting point, or reconfigured to a new set of rules.

By the wording “verification attempt”, it is herein meant the process of verifying whether the authentication pattern matches the verification pattern or not. A failed verification attempt thus refers to the case when the authentication pattern does not match the verification pattern. Correspondingly, a successful verification attempt refers to the case when the authentication pattern matches the verification pattern. It goes without saying that the wording verification attempt may also refer to a process of verifying a first and/or second authentication response, as is further explained below.

In response to the authentication pattern matching the verification pattern, the method 100 further comprises performing S112 a wake-up process of the wireless device. In other words, the wake-up process is not initiated until the wake-up signal has been verified. Performing S112 the wake-up process may comprise transforming the wireless device from a first operating mode to a second operating mode. The first operating mode may correspond to an idle (or sleep) mode. The second operating mode may correspond to an active (or awake) mode. The wireless device, when in the first operating mode, may have a lower power consumption than in the second operating mode.

As will be further described below, in connection with FIGS. 5A and 5B, the wireless device may comprise a first and a second circuit. The first circuit may have a lower power consumption than the second circuit. Thus, the first circuit may be operating when the wireless device is in the first operating mode. In other words, the first circuit may perform any functions and control of the wireless device when the wireless device is in the first operating mode. Correspondingly, the second circuit may be operating when the wireless device is in the second operating mode.

In some embodiments, the steps prior to the step of S112 of the method 100, may be performed by the first circuit. In particular, the steps of receiving S102 the wake-up signal and determining S106 whether or not the authentication pattern matches the verification pattern may be performed by the first circuit.

In response to the authentication pattern matching the verification pattern (Yes path from S106 Match), the method 100 further comprises transmitting S114 an acknowledgement signal to the radio node. The acknowledgement signal may comprise information indicative of the wireless device being awake, or are in the process of waking up. Even though the step of transmitting S114 the acknowledgement signal is illustrated as occurring after the step of performing S112 the wake-up process, the acknowledgement signal may alternatively be transmitted prior to, or in connection with, performing S112 the wake-up process.

If instead it is determined that the authentication pattern does not match the verification pattern (No path from S106 Match), the wireless device may terminate the method (not shown in FIG. 1). Thus, the wireless device need not to transmit any response signals to the radio node, thereby avoiding giving away or reporting its presence.

In some embodiments, the method 100 further comprises, in response to the authentication pattern not matching the verification pattern (No path from S106 Match), increasing S116 a count (or counter) of failed verification attempts by one. In other words, the wireless device may keep track of the number of failed verification attempts (i.e. each time the authentication pattern is determined not to match the verification pattern). The failed verification attempts may give an indication of how many times malicious wake-up attempts has been detected, which in turn may be used to take action. For example, in response to the count of failed verification attempts being above a threshold, the method 100 may further comprise transmitting S118 a notification signal to the radio node. In such case, the wireless device may perform the wake-up process and then transmit S118 the notification signal. Alternatively, the notification signal may be transmitted S118 by a low power transmitter of the wireless device, without having to perform the wake-up process. The notification signal may indicate that the count of failed verification attempts has exceeded the threshold and/or include the count of failed verification attempts. Reconfiguring S120 the set of rules as described above may be performed in response to the threshold being exceeded. This may e.g. be initiated by the wireless device directly by transmitting an indication of a request for an updated set of rules, or by the radio node in response to receiving the notification signal. The threshold may be a programmable threshold, e.g. by being set to different values depending on the situation. The threshold may for instance specify a limit for a total number of failed wake-up attempts, or a limit for a number of failed wake-up attempts within a certain time range. In case the count of failed verification attempts during the certain time range is above the threshold, the wireless device may be configured to stop (during a limited time period) receiving wake-up signals, as it may indicate a risk of draining a battery of the wireless device.

In some embodiments, the method 100 further comprises transmitting the count of failed verification attempts to the radio node in response to having verified a received wake-up signal. For example, the count of failed verification attempts may be transmitted in connection with the acknowledgement signal.

In some embodiments, the method 100 further comprises transmitting the count of failed verification attempts to a further radio node. The further radio node may be configured to keep track of malicious verification attempts (or attacks). The further radio node may be a trusted radio node in a same network or system as the wireless device, and be responsible for the network or system security. Further, in some embodiments, the count of failed verification attempts is transmitted by multicast transmission to a number of selected radio nodes.

The method 100 as described so far may be referred to as a 2-way handshake verification process. For improved security and reliability, a 4-way handshake verification process may be used as described in the following. In response to the authentication pattern matching the verification pattern (Yes-path from S106 Match), the method 100 may further comprise transmitting S108, to the radio node, a first authentication response. The method 100 may further comprise receiving S110 a second authentication response from the radio node. The second authentication response may be received in response to the first authentication response being verified by the radio node. In response to the second authentication response being verified by the wireless device, the wake-up process may be performed S112. Put differently, in addition to the verification of the authentication pattern, the first and second authentication responses, which are communicated between the radio node and the wireless device, also have to be verified before the wake-up process is performed S112. The first and second authentication responses may comprise a respective further authentication pattern determined by the same set of rules used in determining the (previously described first) authentication pattern of the wake-up signal and the verification pattern used for verifying said (first) authentication pattern. Hence, the first and second authentication responses may be verified by determining a respective further verification pattern used to match against the further authentication patterns of the first and second authentication responses. However, in some embodiments, the first and second authentication responses are based on a different verification process than the verification of the (first) authentication pattern of the wake-up signal.

In some embodiments, the wake-up signal may further comprise a target identification, ID, indicating an intended wireless device. The method 100 may then further comprise determining S104 whether the target ID matches a device ID of the wireless device. Determining S106 whether or not the authentication pattern matches a verification pattern of the wireless device may then be performed in response to the target ID matching the device ID. Put differently, if there is a match, the method 100 proceeds to the step denoted S106. Even though not shown, if there is no match between the target ID and the device ID, the method 100 may be terminated or return to the step denoted S102 to receive another wake-up signal. The target ID may be used as a first check to see if the wake-up signal is intended for the wireless device. In case the target ID does not match the device ID, the wireless device may ignore the received wake-up signal. The target ID may indicate an individual wireless device. Alternatively, the target ID may indicate a group of wireless devices. The group of wireless devices may be a specified set of individual wireless devices. Alternatively, the group of wireless devices may indicate a category of wireless devices. Thus, all wireless devices belonging to a certain category can be targeted, regardless of how many devices there are in that category.

Now turning back to the authentication/verification process, i.e. the authentication and verification pattern and the set of rules used to determine them. In some embodiments, the set of rules define a Linear Feedback Shift Register (LFSR). In such case, the authentication pattern and the verification pattern is each a sequence generated by the Linear Feedback Shift Register. As realized by the inventors, the use of LFSRs is particularly advantageous in that they are computationally efficient to compute, due to their relatively simple building blocks. This means that they can be computed and compared using simple circuitry, such as a low power circuit (e.g. the first circuit) as explained herein.

In the field of computing, LFSR is a well-known shift register that can be used to generate pseudorandom binary sequences (PRBS). The PRBS (also referred to as LFSR sequence) is a sequence of binary numbers that, while generated by the deterministic function that is the LFSR, appears to be random and is difficult to predict. In general, the LFSR starts from an initial state, also referred to as a seed. The seed is a binary sequence of a certain length, m. Starting from this initial state, the LFSR can produce a stream of bits by cycling through the LFSR. In each cycle, the state of the LFSR changes depending on a chosen feedback function and the previous state, and a bit is outputted. The operation of the LFSR is deterministic, meaning that the next state is completely determined by the current state of the LFSR and that a certain LFSR always generates the same stream of bits. The feedback function may be defined by positions of a number of taps. The positions herein refer to different positions of the state of the LFSR. If for example, the length of the LFSR state, m, is equal to 16, then the taps may be positioned at any one of the first to sixteenth bit of the LFSR state, such as at bit number 11, 13, 14 and 16. The LFSR (and the location of the taps) may be defined by a so-called LFSR polynomial. The taps may e.g. be a number of XOR or XNOR gates which functions as a feedback of the LFSR. One example of well-known LFSRs is the so called Fibonacci LFSRs. In each cycle, the bits at the position of the taps are fed through the XOR (or XNOR) gates, and the output is fed back into the LFSR. Another example of well-known LFSRs is the so called Galois LFSRs. Both Fibonacci LFSRs and Galois LFSRs may be used for the embodiments disclosed herein. However, other LFSRs may be used as well.

Another property of the LFSR is the sequence length, n, that is generated. In other words, the number of outputted bits, or number of cycles of the LFSR that is performed. Running the LFSR over e.g. 10 cycles will generate a LFSR sequence of n=10.

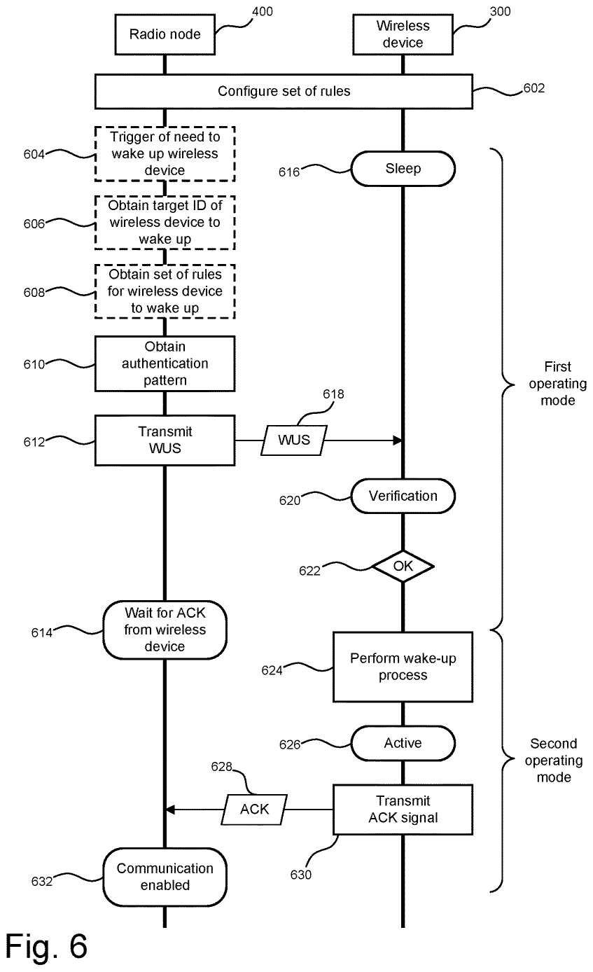

The set of rules as described above may therefore be interpreted as any properties used to define a LFSR. More specifically, the set of rules may comprise a seed and a location of taps of the Linear Feedback Shift Register and a sequence length of the authentication pattern. The sequence length of the authentication pattern is in other words a length of the LFSR sequence generated. How a LFSR can be used as part of the present disclosure will be further described, in more practical terms, in connection with FIG. 6 to 8. Reconfiguring S120 the set of rules may comprise changing one or more of the above mentioned properties of the LFSR. As an example, the state of the LFSR (i.e. of the wireless device and the radio node) may be reset to the seed state. As another example, the state of the LFSR may be set to a new seed value, different from the previous seed value. An event that may cause the set of rules to be reconfigured S120 may be that the LFSRs of the radio node and the wireless device get out of sync, i.e. that the LFSRs of the radio node and the wireless device no longer have matching states. For example, the wireless device may accidentally have generated more LFSR sequences than the radio node. The radio node (or the wireless device) may decide to reconfigure the set of rules also under normal working operations, such as at periodic intervals, when the LFSR sequence reaches its end, etc.

Executable instructions for performing these functions are, optionally, included in a computer-accessible medium such as a non-transitory computer-readable storage medium or other computer program product configured for execution by one or more processors.

Generally speaking, a computer-accessible medium may include any tangible or non-transitory storage media or memory media such as electronic, magnetic, or optical media—e.g., disk or CD/DVD-ROM coupled to computer system via bus. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

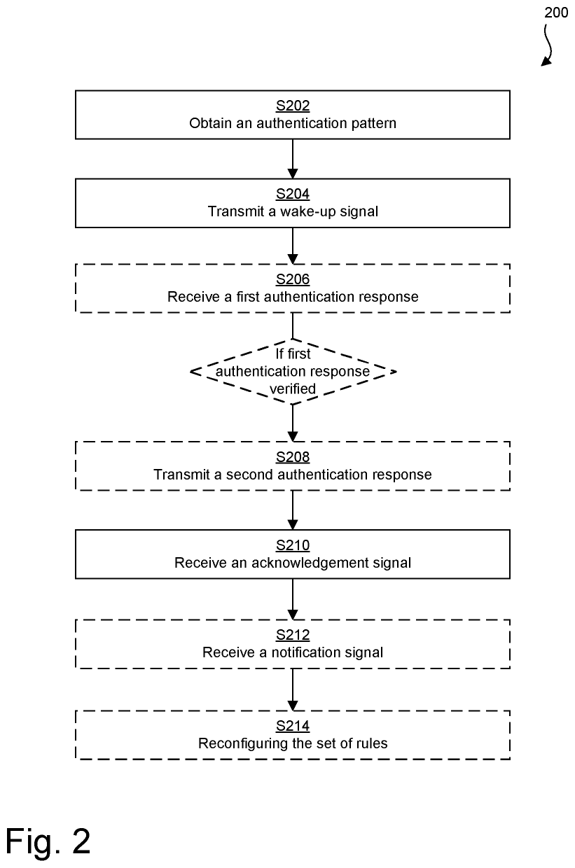

FIG. 2 is a flowchart illustrating some embodiments of a method 200 performed in a radio node. It should be appreciated that the method 200 of FIG. 2 comprises some steps which are illustrated as boxes in solid lines and some steps which are illustrated in dashed lines. The steps which are shown in solid lines are steps which are comprised in the broadest example embodiment of the method 200. The steps which are comprised in dashed lines are examples of a number of optional steps which may form part of a number of alternative embodiments. It should be appreciated that the optional steps need not be performed in order. Furthermore, it should be appreciated that not all of the steps need to be performed. The example steps may be performed in any order and in any combination.

In more detail, the presently disclosed method 200 should be understood as describing the steps performed in the radio node for transforming the wireless device from the first operating mode to the second operating mode as described above in connection with FIG. 1. In other words, the method 200 describes the steps performed by a radio node to wake up a wireless device. Thus, the method 200 described in connection with FIG. 2 may be seen as being interrelated to the method 100 described in connection with FIG. 1. Therefore, it goes without saying that any principles described with respect to one of the methods may be applicable also to the other method, unless otherwise stated.

As described above, the radio node may e.g. be a base station, a gateway or a wireless device acting as a relay node in a communication network. A radio node according to some embodiments of the present disclosure is further described in connection with FIG. 4 below.

In the following, the different steps are described in more detail with reference to FIG. 2. Even though illustrated in a specific order, the steps of the method 200 (both the steps illustrated in solid lines and in dashed lines) may be performed in any suitable order, in parallel, as well as multiple times.

The method 200 comprises obtaining S202 an authentication pattern determined according to a configured set of rules for a wireless device. In other words, the authentication pattern is determined according to a set of rules associated with a wireless device which are to be woken up.

The term “obtaining” is to, throughout the present disclosure, be interpreted broadly and encompasses receiving, retrieving, collecting, acquiring, and so forth directly and/or indirectly between two entities configured to be in communication with each other or further with other external entities. Obtaining S202 the authentication pattern may for instance comprise receiving the authentication pattern from a base station (if the radio node is not the base station itself) or a remote application server. Alternatively, obtaining the authentication pattern may comprise determining the authentication pattern by the radio node itself. Obtaining S202 the authentication pattern may further comprise retrieving the set of rules associated with the wireless device to which the wake-up signal is to be transmitted. The set of rules may e.g. be stored and retrieved from a memory of the radio node, from a base station, from another radio node, or from a remote server in communication with the radio node.

As described above in connection with FIG. 1, the authentication pattern may be determined according to the same set of rules as the verification pattern of the wireless device. Further, the set of rules for the wireless device may be configured at a point in time prior to the wake-up signal being transmitted S204.

In case of the radio node being a relay node, the radio node may receive a normal wake-up signal (i.e., a wake-up signal without an authentication pattern) from the BS and relay the wake-up signal together with the authentication pattern to a single or group of wireless devices. Put differently, the radio node (as a relay node) may add the authentication pattern to the wake-up signal, before transmitting it to the wireless device.

Optionally, the method may further comprise reconfiguring S214 the set of rules. The set of rules may be reconfigured S214 at a time interval. Alternatively, the set of rules may be reconfigured S214 in response to an event occurring. How and when the reconfiguring S214 of the set of rules may be performed is further explained above in connection with FIG. 1. To avoid undue repetition, reference is made to the above.

Moving on, the method 200 further comprises transmitting S204 a wake-up signal to the wireless device. The wake-up signal comprises the authentication pattern. The authentication pattern may be provided in a configured sequence field of the wake-up signal. The sequence field may be agreed upon between the radio node and the wireless device prior to transmitting S204 the wake-up signal. Alternatively, a flag may be provided with the wake-up signal, indicating the presence of the authentication pattern.

The method 200 further comprises receiving S210 an acknowledgement signal from the wireless device. The acknowledgement signal is received S210 in response to the authentication pattern matching a verification pattern of the wireless device. Put differently, the acknowledgement signal is received after (and if) the wireless device has verified the wake-up signal. In some embodiments, if the acknowledgement signal has not been received after a certain amount of time from transmitting the wake-up signal, the method 200 may be terminated. Alternatively, the radio node may start over with the verification process by transmitting the wake-up signal again.

Optionally, the method 200 may further comprise receiving S212 a notification signal from the wireless device. The notification signal may be indicative of a count of failed verification attempts of the wireless device being above a threshold. Upon receiving the notification signal, the radio node may transmit an updated set of rules to the wireless device.

In some embodiments, the method 200 further comprises receiving S206 a first authentication response from the wireless device. The first authentication response may be received S206 in response to the authentication pattern of the wake-up signal being verified by the wireless device. The method may further comprise transmitting S208 a second verification response to the wireless device, in response to the first authentication response being verified by the radio node. The acknowledgement signal may then be received S210 in response to the second verification response being verified by the wireless device. The first and second authentication responses may provide for additional security since two additional verification steps is performed (as explained above in conjunction with the 4-way handshake of the method 100).

The wake-up signal may further comprise a target identification, ID, indicating the intended wireless device. The target ID may indicate an individual wireless device, or a group of wireless devices. Transmitting S204 the wake-up signal may be performed by broadcasting the wake-up signal. The target ID may then allow for only wireless devices having a device ID matching the target ID to be addressed.

The target ID may comprise a sequence of numbers or characters separate from the authentication pattern. Alternatively, the authentication pattern may serve also as a target ID. In some embodiments, the set of rules of a wireless device may be selected to distinguish a wireless device, or group of wireless devices (e.g. belonging to a same category) from other wireless devices. In case a LFSR sequence is used, the sequence length may for instance be utilized as a target ID, such as having a first sequence length to target a first set of wireless devices, and a second sequence length to target a second set of wireless devices. To determine whether the target ID matches a device ID, the wireless device may then check that the sequence length of the authentication pattern is equal to a sequence length defined by the device ID.

The set of rules (and thus the authentication pattern) may be used as a target ID. For example, wireless devices of a group (such as a category of wireless devices) may have the same set of rules (e.g. the same LFSR). Alternatively, the wireless device may have a unique set of rules. Thus, the proposed solution may allow for targeted wake-up signaling by selection of what set of rules are used to determine the verification pattern.

In the case of LFSR sequences, the LFSR sequence and/or the target ID may be adapted by changing certain bits, i.e. by performing bit fiddling of the LFSR sequence. This may further increase uniqueness of the LFSR sequence and/or target ID. As an example, bitwise XOR may be applied to the LFSR sequence and/or target ID, either partially or at full length.

As described above in connection with FIG. 1, the set of rules may define a LFSR. The authentication pattern and the verification pattern may thus be a sequence generated by the LFSR. Further, also the first and second authentication responses may comprise sequences generated by the LFSR. The set of rules may comprise a seed and a location of taps of the LFSR and a sequence length of the authentication pattern.

Executable instructions for performing these functions are, optionally, included in a computer-accessible medium such as a non-transitory computer-readable storage medium or other computer program product configured for execution by one or more processors.

FIG. 3 is a schematic illustration of a wireless device 300 according to some embodiments. In particular, the wireless device 300 is configured to perform the techniques described in the foregoing with reference to FIG. 1.

The wireless device 300 comprises control circuitry 302. The control circuitry 302 may physically comprise one single circuitry device. Alternatively, the control circuitry 302 may be distributed over several circuitry devices. Functions and operations of the control circuitry 302 may thus be distributed over the different circuitry devices.

As shown in the example of FIG. 3, the wireless device 300 may further comprise a transceiver 306 and a memory 308. The control circuitry 302 is communicatively connected to the transceiver 306 and the memory 308. The control circuitry 302 may comprise a data bus. The control circuitry 302 may communicate with the transceiver 306 and/or the memory 308 via the data bus.

The control circuitry 302 may be configured to carry out overall control of functions and operations of the wireless device 300. The control circuitry 302 may be any suitable type of computation unit. The control circuitry 302 may comprise a processor 304, such as a central processing unit (CPU), microcontroller, microprocessor, digital signal processor (DSP), field programmable gate array (FPGA), application specific integrated circuit (ASIC) or any other form of circuit. The processor 304 may be configured to execute program code stored in the memory 308, in order to carry out functions and operations of the wireless device 300. The control circuitry 302 is configured to perform the steps of the method 100 as described above in connection with FIG. 1. The steps may be implemented in one or more functions stored in the memory 308.

The transceiver 306 may be configured to enable the wireless device 300 to communicate with other devices. The transceiver 306 may thus both transmit and receive data. Even though illustrated as a single unit, the transceiver 306 may be distributed over several transceiver units of the wireless device 300. The transceiver 306 may be configured to communicate over one or more communication protocol known in the art. Examples include, but are not limited to, long range radio communication technologies (e.g. cellular radio technologies such as GSM, GPRS, EDGE, LTE, LTE-Advanced, 5G, 5G NR, 6G, and so on), as well as short to mid-range technologies such as Wi-Fi, Bluetooth, Wireless Local Area (LAN), e.g. IEEE 802.11 etc.

Even though not explicitly illustrated in FIG. 3, the wireless device 300 may further comprise means for receiving user input, such as one or more of a keyboard, a mouse, and a touchscreen etc. The wireless device 300 may further comprise means for displaying information to a user, such as a display. The wireless device 300 may further comprise means for obtaining sensor data.

The memory 308 may be configured to store received or transmitted data and/or executable program instructions. The memory 308 may also be configured to store any form of beamforming information, reference signals, and/or feedback data or information. The memory 308 may be any suitable type of computer readable memory and may be of volatile and/or non-volatile type. The memory 308 may for instance be one or more of a buffer, a flash memory, a hard drive, a removable media, a volatile memory, a non-volatile memory, a random access memory (RAM), or another suitable device. The memory 308 may be a non-transitory computer-readable storage medium. In a typical arrangement, the memory 308 may include a non-volatile memory for long term data storage and a volatile memory that functions as system memory for the wireless device 300. The memory 308 may exchange data with the circuitry 302 over the data bus. Accompanying control lines and an address bus between the memory 308 and the circuitry 302 also may be present.

Functions and operations of the wireless device 300 may be implemented in the form of executable logic routines (e.g., lines of code, software programs, etc.) that are stored on a non-transitory computer readable recording medium (e.g., the memory 308) of the wireless device 300 and are executed by the circuitry 302 (e.g. using the processor 304). Put differently, when it is stated that the circuitry 302 is configured to execute a specific function or operation, the processor 304 of the circuitry 302 may be configured to execute program code portions stored on the memory 308, wherein the stored program code portions correspond to the specific function or operation. Furthermore, the functions and operations of the circuitry 302 may be a stand-alone software application or form a part of a software application that carries out additional tasks related to the circuitry 302. The described functions and operations may be considered a method which the corresponding device is configured to carry out, such as the method 100 discussed above in connection with FIG. 1. Also, while the described functions and operations may be implemented in software, such functionality may as well be carried out via dedicated hardware or firmware, or some combination of one or more of hardware, firmware, and software. In the following, the function and operations of the wireless device 300 is described.

The control circuitry 302 is configured to receive a wake-up signal from a radio node. The wake-up signal comprises an authentication pattern. Receiving the wake-up signal may be performed e.g. by execution (by the control circuitry 302) of a receiving function. The wake-up signal may be received by the transceiver 306.

The control circuitry 302 is further configured to determine whether or not the authentication pattern matches a verification pattern of the wireless device 300. The verification pattern is determined according to a configured set of rules. Determining whether or not the authentication pattern matches the verification pattern of the wireless device 300 may be performed e.g. by execution (by the control circuitry 302) of a determining function.

In response to the authentication pattern matching the verification pattern, the control circuitry 302 is further configured to perform a wake-up process of the wireless device 300. Performing the wake-up process may be performed e.g. by execution (by the control circuitry 302) of a wake-up function.

In response to the authentication pattern matching the verification pattern, the control circuitry 302 is further configured to transmit an acknowledgement signal to the radio node. Transmitting the acknowledgement signal may be performed e.g. by execution (by the control circuitry 302) of a transmitting function. The acknowledgement signal may be transmitted by the transceiver 306.

As explained above in connection with FIGS. 1 and 2, an LFSR may be used to generate the authentication and verification patterns used in the verification process. In some embodiments, the LFSR is implemented as a separate hardware component in the wireless device 300, e.g. as an LFSR module 310. Thus, the wireless device 300 may further comprise the LFSR module 310. The LFSR module 310 may comprise the set of rules of the LFSR. The LFSR module 310 may be configured to keep track of the state of the LFSR and generate LFSR sequences. The LFSR module 310 may be further configured to take care of the reconfiguring of the set of rules. As illustrated herein, the LFSR module 310 may be communicatively connected to the control circuitry 302 for transmitting and receiving data (such as LFSR sequences). In some embodiments, the LFSR is implemented as software. In such case, the functions of the LFSR module 310 described above may be implemented in other components of the wireless device (such as the control circuitry 302, the transceiver 306 and the memory 308).

One advantage with implementing the LFSR as a hardware component is that it typically requires less energy to operate than a software implementation. For devices where it is imperative that power is conserved as much as possible, it may be beneficial to rely on a hardware implementation of the LFSR.

However, one advantage with implementing the LFSR as a software component is that requires less physical area, and this may be beneficial in some embodiments.

It should be appreciated that any features, aspects and advantages of the method 100 as described above in connection with FIG. 1, are applicable also to the wireless device 300 described herein. To avoid undue repetition, reference is made to the above.

It will become apparent from below, in connection with FIGS. 5A and 5B, that the wireless device may comprise a first and a second circuit. Thus, even though the wireless device 300 is illustrated in FIG. 3 as having a single control circuitry 302, a transceiver 306 and a memory 308, these may be split into two or more separate components.

FIG. 4 is a schematic illustration of a radio node 400 according to some embodiments. In particular, the radio node 400 is configured to perform the techniques described in the foregoing with reference to FIG. 2. As described above, the radio node 400 may be a relay node, such as a further wireless device. Thus, the radio node 400 may have a same structure as the wireless device 300, as described above in connection with FIG. 3. Alternatively, the radio node 400 may be a base station or the like.

The radio node 400 comprises control circuitry 402. The control circuitry 402 may physically comprise one single circuitry device. Alternatively, the control circuitry 402 may be distributed over several circuitry devices.

As shown in the example of FIG. 4, the radio node 400 may further comprise a transceiver 406 and a memory 408. The control circuitry 402 is communicatively connected to the transceiver 406 and the memory 408. The control circuitry 402 may comprise a data bus. The control circuitry 402 may communicate with the transceiver 406 and/or the memory 408 via the data bus.

The control circuitry 402 may be configured to carry out overall control of functions and operations of the radio node 400. The control circuitry 402 may be any suitable type of computation unit. The control circuitry 402 may comprise a processor 404, such as a central processing unit (CPU), microcontroller, microprocessor, digital signal processor (DSP), field programmable gate array (FPGA), application specific integrated circuit (ASIC) or any other form of circuit. The processor 404 may be configured to execute program code stored in the memory 408, in order to carry out functions and operations of the radio node 400. The control circuitry 402 is configured to perform the steps of the method 200 as described above in connection with FIG. 2. The steps may be implemented in one or more functions stored in the memory 408.

The transceiver 406 may be configured to enable the radio node 400 to communicate with other devices, such as wireless devices, other radio nodes (e.g., base stations or relay nodes), etc. The transceiver 406 may thus both transmit and receive data. Even though illustrated as a single unit, the transceiver 406 may be distributed over several transceiver units of the radio node 400. The transceiver 406 may be configured to communicate over one or more communication protocol known in the art. Examples include, but are not limited to, long range radio communication technologies (e.g. cellular radio technologies such as GSM, GPRS, EDGE, LTE, LTE-Advanced, 5G, 5G NR, 6G and so on), as well as short to mid-range technologies such as Wi-Fi, Bluetooth, Wireless Local Area (LAN), e.g. IEEE 802.11 etc.

Even though not explicitly illustrated in FIG. 4, the radio node 400 may further comprise means for receiving user input, such as one or more of a keyboard, a mouse, and a touchscreen etc. The radio node 400 may further comprise means for displaying information to a user, such as a display.

The memory 408 may be configured to store received or transmitted data and/or executable program instructions. The memory 408 may also be configured to store any form of beamforming information, reference signals, and/or feedback data or information. The memory 408 may be any suitable type of computer readable memory and may be of volatile and/or non-volatile type. The memory 408 may for instance be one or more of a buffer, a flash memory, a hard drive, a removable media, a volatile memory, a non-volatile memory, a random access memory (RAM), or another suitable device. The memory 408 may be a non-transitory computer-readable storage medium. In a typical arrangement, the memory 408 may include a non-volatile memory for long term data storage and a volatile memory that functions as system memory for the radio node 400. The memory 408 may exchange data with the circuitry 402 over the data bus. Accompanying control lines and an address bus between the memory 408 and the circuitry 402 also may be present.

Functions and operations of the radio node 400 may be implemented in the form of executable logic routines (e.g., lines of code, software programs, etc.) that are stored on a non-transitory computer readable recording medium (e.g., the memory 408) of the radio node 400 and are executed by the circuitry 402 (e.g. using the processor 404). Put differently, when it is stated that the circuitry 402 is configured to execute a specific function or operation, the processor 404 of the circuitry 402 may be configured execute program code portions stored on the memory 408, wherein the stored program code portions correspond to the specific function or operation. Furthermore, the functions and operations of the circuitry 402 may be a stand-alone software application or form a part of a software application that carries out additional tasks related to the circuitry 402. The described functions and operations may be considered a method that the corresponding device is configured to carry out, such as the method 200 discussed above in connection with FIG. 2. Also, while the described functions and operations may be implemented in software, such functionality may as well be carried out via dedicated hardware or firmware, or some combination of one or more of hardware, firmware, and software.

In the following, the function and operations of the radio node 400 is described.

The control circuitry 402 is configured to obtain an authentication pattern determined according to a configured set of rules for a wireless device. Obtaining the authentication pattern may be performed e.g. by execution (by the control circuitry 402) of an obtaining function.

The control circuitry 402 is further configured to transmit a wake-up signal to the wireless device. The wake-up signal comprises the authentication pattern. Transmitting the wake-up signal may be performed e.g. by execution (by the control circuitry 402) of a transmitting function. The wake-up signal may be transmitted by the transceiver 406.

The control circuitry 402 is further configured to receive an acknowledgement signal from the wireless device, in response to the authentication pattern matching a verification pattern of the wireless device.

Receiving the acknowledgement signal may be performed e.g. by execution (by the control circuitry 402) of a receiving function. The acknowledgement signal may be received by the transceiver 406.

The radio node 400 may further comprise an LFSR module 410, in the same way as explained above in connection with the LFSR module 310 of FIG. 3. This may correspond to a hardware implementation of the LFSR. However, as with the wireless device 300, the LFSR may also be implemented as software.

It should be appreciated that any features, aspects and advantages of the method 200 as described above in connection with FIG. 2, are applicable also to the radio node 400 described herein. To avoid undue repetition, reference is made to the above.

FIGS. 5A and 5B are block diagrams of some example configurations of a wireless device 500 according to some embodiments. In particular, FIGS. 5A and 5B illustrate two different examples of how the wireless device 500 may be realized with a distributed power domain. Put differently, the wireless device 500 may be realized with a separated power domain. It should be appreciated that the aspects described herein in connection with FIGS. 5A and 5B are applicable to the wireless device 300 as described throughout the present disclosure. Thus, the wireless device 500 as described in connection with FIGS. 5A and 5B may be the same entity as the wireless device 300 described in the foregoing. The aspects presented in the following may also be applicable to the radio node 400, in particular in the case when the radio node 400 is a further wireless device.

As has been described in the forgoing, the present disclosure facilitates improvements relating to wake-up signaling of low power wireless devices 500. Typically, low power devices have components or circuits that reside in different power domains. In particular, the wireless device 500, as illustrated herein, has a first power domain 502 and a second power domain 504. The first power domain 502 should be seen as a low power or always on power domain. By the wording “always on”, as used e.g. in “always on circuit” or “always on power domain”, it is herein meant that circuit or power domain remains in a continuously or periodically active state, such that the wireless device 500 is able to receive and act on any signals (e.g. wake-up signals) that is sent to the wireless device 500. In a continuously active state, the wireless device 500 may be constantly active and listening for signals. In a periodically active state, the wireless device may be active and listen for signals at a high enough frequency to detect the signals, or at certain time instances at which the wireless device 500 knows that a signal may be received. As another way of seeing it, “always on” may be construed as being active more often, and/or for longer periods than the second power domain 504 which is not an always-on power domain.

The first power domain 502 may for instance run on a sleep clock. The sleep clock may operate at a frequency lower than a frequency needed for full functional operation of the second power domain 504.

The sleep clock may for instance operate within the range of 10-100 kHz, such as e.g. 32 kHz. The first power domain 502 may thus be tasked with maintaining essential functions of the wireless device 500, or other tasks that can be performed using limited resources. The first power domain 502 may have limited computational resources. In the present disclosure, the first power domain 502 is configured to perform the verification process of the wake-up signal. The second power domain 504 should be seen as a switchable power domain (typically having higher power consumption than the first power domain 502). The second power domain 504 may for instance run on a main (transceiver) functionality clock (or system reference clock). The main (transceiver) functionality clock may operate at an order of magnitude greater than the sleep clock. For instance, the main (transceiver) functionality clock may operate within the range of 10-100 MHz, such as e.g., 25 MHz. The second power domain 504 is thus configured to be switched on when needed (e.g. in response to the wake-up process being performed). Otherwise, the second power domain 504 may be in a sleep or idle mode, e.g. for conserving energy.

In more concrete terms, the wireless device 500 depicted herein comprises a first and second circuit 506, 508 for realizing the first and second power domain 502, 504 respectively. The first and second circuit 506, 508 may be two separate devices. The first and second circuit 506, 508 may have a respective control circuitry (i.e. processing circuitry), memory and transceiver. The respective components may have different properties, such as different processing power/capability, or transceivers communicating over different communication protocols.

In some embodiments, the first circuit 506 comprises a receiver, while the second circuit 508 comprises a transceiver. Thus, the first circuit 506 may be configured to only receive data, while the second circuit 508 is configured to both receive and transmit data. Such a configuration may be advantageous in that the first circuitry 506 can be made very simple, and requiring low power supply. It may further ensure that the wireless device 500 stays in stealth mode (i.e. does not give away its presence by transmitting any signals) until the wake-up process is performed. In some embodiments, both the first circuit 506 and the second circuit 508 comprises transceivers. Thus, both the first and the second circuit 506, 508 may be configured to both transmit and receive data.

As an alternative to separate devices, the first and second circuit 506, 508 may be implemented as a common device using the same components, or partly the same components. For example, the first and second circuit may be achieved by software limitation, such that in the first operating mode (corresponding to the first circuit), the wireless device 500 operates in a performance limited mode (limited by software), while in the second operating mode, the wireless device 500 operates in a non-limited mode. As an example of partly the same components, the first and second circuit 506, 508 may share one or more components, such as a common memory, or a common transceiver. It should be appreciated that the first and second circuit 506, 508 (and in more general, the first and second power domain 502, 504) may be realized in many different ways, and that the examples given herein should not necessarily be limiting to the scope of the present disclosure.

As described above, the first circuit 506 may be an always on circuit, in which it operates having a lower power consumption than the second circuit 508 (when activated). This may e.g. be achieved by limiting a voltage consumption, reducing frequency of operations, reducing complexity of the circuit and/or lowering a supply voltage to the first circuit 506. Alternatively, the first circuit 506 may be clock-gated, or periodically activated (e.g. if it knows when it can expect to receive a wake-up signal) to still achieve a low power consumption over time. As has been explained above, the first circuitry 506 is configured to perform the steps of the method 100 up until the wake-up process of the wireless device 500 has been performed. The first circuitry 506 as illustrated herein comprises a WUS processing unit 512 which may be configured to perform these steps. In particular, the first circuit 506 is configured to communicate with a radio node (e.g. receiving a wake-up signal, and optionally transmitting and receiving a first and second authentication response), and perform the verification process (e.g. determining a verification pattern and comparing it to a received authentication pattern). As is readily understood by a person skilled in the art, the functions and operations of the wireless device 500 may be distributed over any suitable number of blocks. Upon verifying a wake-up signal (as explained above), the first circuit 506 performs the wake-up process, causing the second circuit 508 to be activated (as indicated by the arrow pointing from the WUS processing unit 512 to the second circuit 508).

In some embodiments, and as shown in both FIGS. 5A and 5B, the wireless device 300 further comprises an LFSR module 520. The LFSR module 520 illustrated herein is to be understood to have the same functions as the LFSR module 310 described above in connection with FIG. 3. Herein, the LFSR module 520 is implemented as a separate component from the WUS processing unit 512, and communicatively connected thereto. Upon request from the WUS processing unit 512, the LFSR module 520 may generate a LFSR sequence, and transmit the LFSR sequence to the WUS processing unit 520. However, in some alternative embodiments, the functions of the LFSR module 520 may be implemented as part of the WUS processing unit 512, or any other suitable component of the wireless device 300, either by hardware or software implementation.

The second circuit 508, which may also be referred to as the main circuit, should be understood as the circuit that is configured to perform the main purpose of the wireless device 500, such as transmitting sensor readings, communicate signals in a communication network, etc.

In some embodiments, and as illustrated herein, the wireless device 500 further comprises a power management unit 510. The power management unit 510 is configured to control which of the first and second power domain 502, 504 (or more particularly, the first and second circuit 506, 508) that are powered, via interface signals. Upon the wake-up signal being verified, the first circuit 506 may transmit a signal to the power management unit 510. The signal may indicate that the power management unit 510 should perform the wake-up process of the second circuit 508.

FIG. 5A further illustrates aspects of some optional embodiments of the wireless device 500 for triggering a wake-up process of the second circuit 508 in response to a number of failed verification attempts. As depicted in dashed lines, the wireless device 500 may further comprise a counter 514 for counting a number of failed verification attempts. A failed verification attempt may either be due to an error, or due to the wake-up signal being sent by malicious intent, e.g. by a malicious node, in a so-called Denial of Service (DoS) attack. In response to the WUS processing unit 512 detecting that a failed verification attempt has occurred, the counter 514 may be increased. The counter 514 may be compared, in a Comparator and Interrupt generator 518, to a threshold. The threshold may be stored in a programmable threshold register 516 of the first circuit 506. In response to the count exceeding the threshold, a wake-up process of the second circuit 508 may be initiated by the Comparator and Interrupt generator 518, e.g. by triggering of an IO signal within the first circuit 506. The triggering of the IO signal may thus result in requesting the turning on of the second circuit 508. The second circuit 508 may then read out the count of failed verification attempts if it is part of a notification signal to be sent to the radio node (or any other authorized node). The second circuit 508 may then transmit the notification signal to the radio node.

According to some embodiments, and as illustrated in FIG. 5B, the wireless device 500 further comprises an low-power transmitter 507, arranged in the first power domain 502 (i.e. as part of the first circuit 506). The low-power transmitted 507 may be an ultra-low power transmitter. The low-power transmitter 507 allows the first circuit 506 to transmit certain data, but at a low power consumption. For example, the low-power transmitter 507 may be configured to transmit a first authentication response, and/or a notification signal, as has been explained above, e.g. in connection with FIG. 1. Having the low-power transmitter 507, may e.g. be advantageous in that the second circuit 508 (or the second power domain 504) can be kept in sleep mode for longer.

It should be appreciated that the illustrated examples of FIGS. 5A and 5B are simplified to show only some aspects. As is readily understood by someone skilled in the art, the wireless device 500 may comprise additional elements, signal crossings, etc.

FIGS. 6, 7 and 8 are a signaling diagrams illustrating, by way of some examples, an exchange of signals between a wireless device 300 and a radio node 400 according to some embodiments of the present disclosure. In the examples of FIG. 6 to 8, the use of Linear Feedback Shift Registers to generate LFSR sequences for performing the verification/authentication process will be described. It should however be appreciated that the illustrated concepts are applicable also to other techniques for generating authentication and verification patterns. For example, any suitable symmetric key based authentication process may be used. The steps described as part of the radio node 400 and the wireless device 300 in FIG. 6 to 8 may be seen as the method 200 of FIG. 2 and the method 100 of FIG. 1 as described above. Any principles described in the following may be applicable also to the methods 100, 200 as described above, and vice versa.

In particular, FIG. 6 illustrates the broadest form of the verification process, namely using a 2-way handshake verification process. The radio node 400 and the wireless device 300 may form part of a system or communication network, either by themselves, or together with further radio nodes and/or wireless devices. Thus, the process described in the following may be performed between several radio nodes and wireless devices simultaneously, or partly simultaneously. As an example, the radio node 400 may transmit a wake-up signal to several wireless devices at the same time. For ease of understanding, only the process between the radio node 400 and the wireless device 300 is shown.

Further, the signaling diagram shows what processes are happening or being performed in the radio node 400 and wireless device 300 respectively, as well as in a sequential order (from top to bottom). However, the signaling diagram should not be seen as indicative of how long time the different processes take.

Prior to transmitting any wake-up signals (WUS), the set of rules are configured (with reference to block 602). As explained in the forgoing, the set of rules may be configured at a first power on of the wireless device 300, e.g. when the wireless device 300 first communicates with the radio node 400. In this example, configuring the set of rules may be interpreted as the radio node 400 and wireless device 300 agreeing upon a LFSR polynomial (i.e. what type of feedback function, number and position of taps), initial state (i.e. seed) and length of the LFSR sequence that is to be generated. The step of configuring the set of rules may be seen as a step performed prior to the method 100 of FIG. 1 and method 200 of FIG. 2.

Moving on to what happens in the radio node 400, the process may be different depending on what kind of radio node it is. For example, if the radio node 400 is a relay node in the communication network, it may receive a trigger of the need to wake up the wireless device 300 (with reference to block 604), from e.g. a base station or a remote application server. If the radio node 400 is a base station itself, it may initiate the process itself.

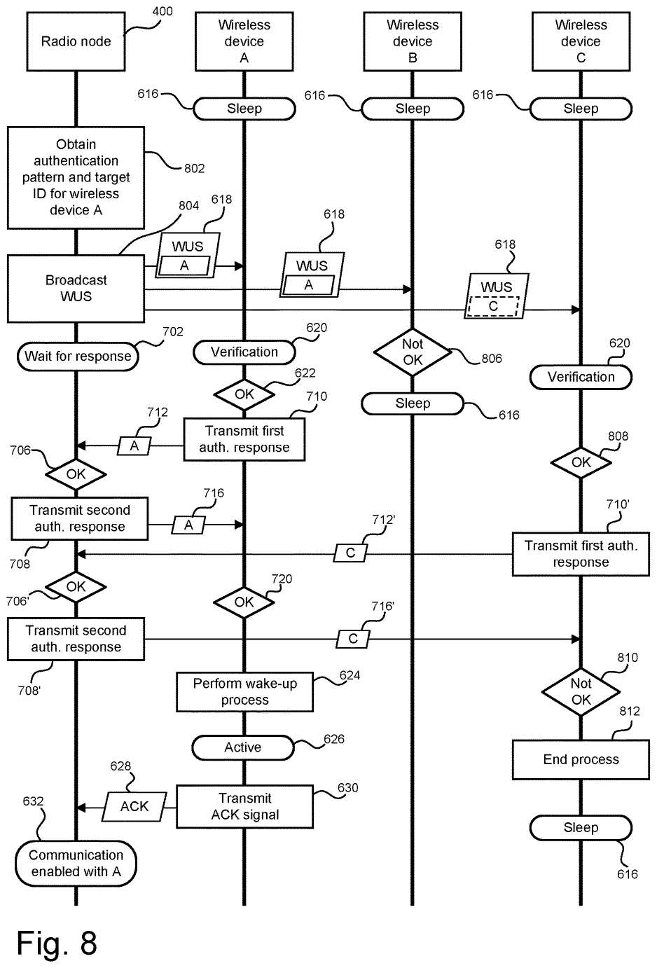

Optionally, the radio node 400 may obtain a target ID of the wireless device 400 which is to be woken up (with reference to block 606), e.g. by receiving the target ID from another entity (e.g. another radio node, a base station, or a remote application server) or looking up the target ID in a memory of the radio node 400. The target ID may be comprised in the wake-up signal (WUS) which is later-on transmitted. The use of target IDs is further described in connection with FIG. 8.

Optionally, the radio node 400 may obtain the set of rules for the wireless device 300 which is to be woken up (with reference to block 608), as the radio node 400 may be configured to communicate with several wireless devices having one or more different sets of rules. As with the target ID, the set of rules may e.g. be received from another entity, or by looking up the set of rules in a memory of the radio node 400.

The radio node 400 may then obtain an authentication pattern (with reference to block 610, and corresponding step S202 in FIG. 2) determined by the set of rules associated with the wireless device 300 to be woken up. The authentication pattern may be obtained e.g. by receiving the authentication pattern from another entity or determining the authentication pattern locally on the radio node 400 using the set of rules.

In the case of using LFSRs to generate the authentication pattern, the authentication pattern is a LFSR sequence generated from a current state of the LFSR. The current state of the LFSR may be the initial state (i.e. seed) in case no authentication pattern has been generated since last configuration of the set of rules. Alternatively, the current state of the LFSR may be the last state it was in (i.e. the final state after generating the last LFSR sequence).

A wake-up signal (WUS) 618 is then transmitted from the radio node 400 to the wireless device 300 (with reference to block 612, and corresponding step S204 of FIG. 2). The WUS comprises the authentication pattern (e.g. the LFSR sequence). The radio node 400 may then await an acknowledgement signal from the wireless device indicating that the wireless device 300 has verified the WUS and has woken up (with reference to block 614).

The wireless device 300 is in a sleep state (with reference to block 616) until it receives the WUS 618 from the radio node 400 (with reference to corresponding step S102 of FIG. 1). In the sleep state, the wireless device 300 may run in a low power operating mode or power saving mode, e.g. by use of the first power domain 502 or first circuit 506 as described above. After receiving the WUS from the radio node 400, the wireless device 300 may transition into a verification state (with reference to block 620). In the verification state, the wireless device 300 determines whether or not the authentication pattern matches a verification pattern of the wireless device 300 (with reference to corresponding step S106 of FIG. 1). Thus, the verification state refers to a state of the wireless device 300 when performing the method step denoted S106 in FIG. 1 above, and up until the wake-up process is performed S112. The wireless device 300 determines the verification pattern using the configured set of rules, and then compares the verification pattern to the authentication pattern to see if they are the same. More specifically, the wireless device 300 determines the verification pattern as a LFSR sequence generated by its LFSR, starting from its current state. Since, in this example, the WUS was received from the radio node 400 of which the wireless device 300 shares the same set of rules with, the LFSR sequence of the WUS (i.e. the authentication pattern) should be the same as the LFSR sequence generated by the wireless device 300 (i.e. the verification pattern), as long they start from the same state. Therefore, the verification is OK (with reference to block 622), and the wireless device 300 proceeds to the next process.

After the authentication pattern has been verified, the wireless device 300 performs a wake-up process (with reference to block 624 and corresponding step S112 of FIG. 1). The wake-up process may comprise transforming the wireless device 300 from a first operating mode to a second operating mode. Put differently, the wireless device 300 may be operating in a first operating mode up until the wake-up process is (or has been) performed. After the wake-up process has been performed, the wireless device 300 operates in a second operating mode. In the second operating mode, the wireless device 300 may operate with full functionality. In other words, the wireless device 300 is in an active state (with reference to block 626) after the wake-up process has been performed. For further details of the first and second operating mode (cf. first and second circuit), reference is made to above, in connection with FIGS. 5A and 5B.

After the wake-up process has been performed, the wireless device 300 transmits an acknowledgement signal (ACK) 628 to the radio node 400 (with reference to block 630 and corresponding step S114 of FIG. 1). Upon receiving the acknowledgement signal (with reference to corresponding step S210 of FIG. 2), the radio node 400 may conclude that communication is enabled to the wireless device 300 (with reference to block 632).

In case the WUS would not have been intended for the wireless device 300 or sent as a malicious attempt of waking up the wireless device 300, the WUS would not comprise an authentication pattern matching the verification pattern of the wireless device 300. In such case, the wireless device may terminate the verification state and go back to the sleep state. This way, unnecessarily waking up the wireless device 300 is avoided. Further, the wireless device 300 may stay in a stealth mode, by not transmitting any response signals to the entity having sent the WUS, thereby avoiding giving away its presence.

After such a failed verification attempt, a reconfiguration of the LFSR of the wireless device 300 may be performed (with reference to corresponding step S214 of FIG. 2 and step S120 of FIG. 1), by resetting the state of the LFSR to the state before the failed verification attempt (i.e. the last state after the last successful verification attempt). This may be to ensure that the LFSR of the wireless device 300 is in the same state as the (legitimate) radio node 400.

FIG. 6 illustrates the case where the verification of the wake-up signal is successful. However, in case the verification of a wake-up signal fails, a count of failed verification attempts may be increased by one, as has been described above in connection with FIG. 1 (step S116). Further, the wireless device may transmit a notification signal to the radio node in response to the count of failed verification attempts is above a threshold (step S118).

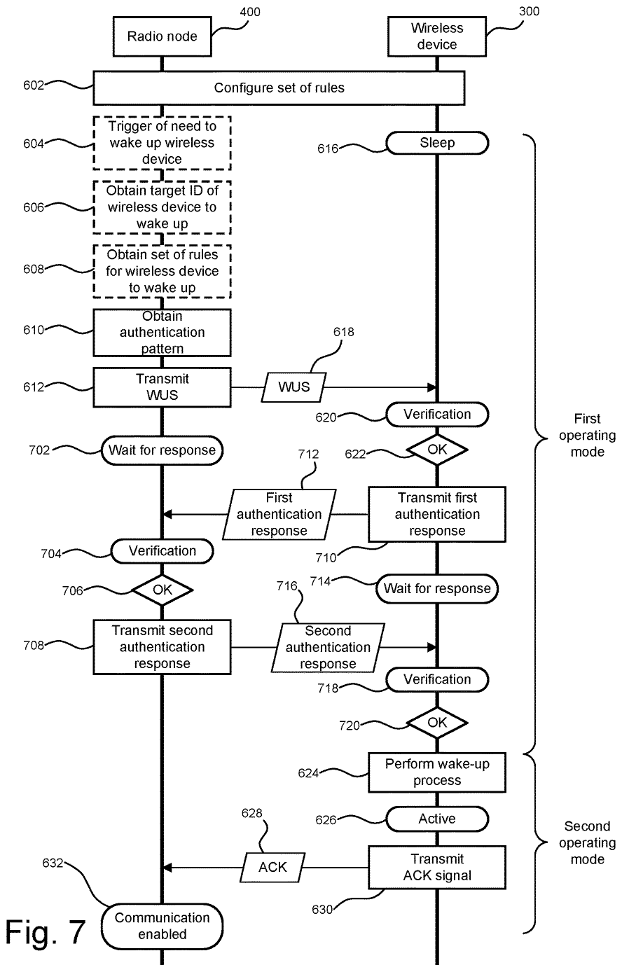

FIG. 7 illustrates, compared to FIG. 6, a signaling diagram of a 4-way handshake verification process as a further example of the present disclosure. Blocks that refer to the same steps as in FIG. 6, has the same reference numbers also in FIG. 7. Reference is made to above.

Up until transmitting the WUS, the process may be the same as in FIG. 6. The authentication pattern of WUS is in the following referred to as a first LFSR sequence. As in the example of FIG. 6, the wireless device 300 determines a verification pattern (i.e. a corresponding first LFSR sequence of its own LFSR) to compare with the authentication pattern. In response to the authentication pattern of the wake-up signal 618 matching the verification pattern (with reference to block 622), the wireless device 300 transmits (with reference to block 710 and corresponding step S108 of FIG. 1) a first authentication response 712 to the radio node. The first authentication response 712 comprises a second LFSR sequence as determined by the wireless device 300. The second LFSR sequence is determined as a subsequent sequence of the first LFSR sequence. In other words, the second LFSR sequence is determined starting from the state which the LFSR ended up in after determining the first LFSR sequence.

The radio node 400, which has been waiting (with reference to block 702) for a response since transmitting the WUS, receives (with reference to corresponding step S206 of FIG. 2) the first authentication response from the wireless device 300. As part of a verification state (with reference to block 704) the radio node 400 then determines a second LFSR sequence of its own LFSR, starting from the current state of the LFSR, which should be the same as the wireless device 300 has when determining the second LFSR sequence. If the second LFSR sequence of the radio node 400 matches the received second LFSR sequence of the first authentication response (with reference to block 706), the radio node 400 determines a third LFSR sequence, starting from the state which the LFSR ended up in, after determining the second LFSR sequence.

The radio node 400 then transmits (with reference to block 708 and corresponding step S208 of FIG. 2) a second authentication response 716, comprising the third LFSR sequence, to the wireless device 300.

The wireless device 300, which has been waiting (with reference to block 714) for a response receives the second authentication response (with reference to corresponding step S110 of FIG. 1). The wireless device again determines a LFSR sequence (i.e. corresponding to a third LFSR sequence of the LFSR of the wireless device 300). The third LFSR sequence of the wireless device 300 is compared to the third LFSR sequence of the received second authentication response to determine whether or not it matches (with reference to block 718). In case it matches (with reference to block 720), the wireless device 300 performs the wake-up process as described above in connection with FIG. 6, and transmits the acknowledgement signal 628 to the radio node 400.

In summary, three sequential LFSR sequences is exchanged between the radio node 400 and the wireless device 300 and verified, before a wake-up process of the wireless device 300 is performed. Since the radio node 400 and the wireless device 300 uses the same set of rules for the LFSR, starting from the same initial state, and the output of the LFSR is deterministic, the radio node 400 and the wireless device 300 stay in sync and generate the same LFSR sequences. The 4-way handshake verification process as presented herein provides more robustness and improved security, as it requires two additional verification steps.

FIG. 8 illustrates a signaling diagram in which a target ID is used to address one or more specific wireless devices among a plurality of wireless devices. FIG. 8 further illustrates how the 4-way handshake verification process may improve the robustness of the process, e.g. by preventing an unintended wireless device to be woken up. As with FIG. 7, the process illustrated herein may further comprise the steps described above in connection with FIG. 6, prior to transmitting the WUS. In addition, the radio node may look up a target ID of the intended wireless device (with reference to block 802). The target ID may then be included in the wake-up signal. Blocks that refer to the same steps as in FIG. 6 or 7, has the same reference numbers also in FIG. 8. Reference is made to above.

In the present example, the wake-up signal 618 is intended for wireless device A. The wake-up signal 618 thus comprises a target ID indicative of wireless device A. The radio node broadcasts (with reference to block 804 and corresponding step S204 of FIG. 2) the wake-up signal 618 comprising the target ID of A, such that it reaches a wireless device A, a wireless device B and a wireless device C.

Looking first at wireless device A. Wireless device A recognizes the target ID as its own device ID. Wireless device A then proceeds to the verification state (with reference to block 620). The process then follows the same procedure as described above in connection with FIG. 7.

Turning now to wireless device B. Wireless device B does not recognize (with reference to block 806) the target ID (e.g. by comparing it to its own device ID). Wireless device B therefore ignores the WUS and continues being in the sleep state (with reference to block 616). Optionally, a count of failed verification attempts may be increased.

Finally, turning to wireless device C, a process where an error occurs in the data transmission is shown. Such situations may occur e.g. because of bit-flips either in the target ID, in the authentication pattern (e.g. the LFSR sequence), or both. In this example, the target ID has been bit-flipped, causing the wireless device C to erroneously interpret the target ID as an ID of C. The wireless device C then goes into the verification state (with reference to block 620) to verify the LFSR sequence of the WUS.

When verifying the LFSR sequence of the WUS, the wireless device C may find that it doesn't match, despite the WUS was thought to be intended for the wireless device C. In such case, the wireless device C may return to the sleep state. However, the LFSR sequence may mistakenly be verified by the wireless device C, as illustrated herein (with reference to block 808), which then transmits (with reference to block 710′ and corresponding step S108 of FIG. 1) a first authentication response 712′ to the radio node.

The radio node may in turn verify the first authentication response 712′ sent from wireless device C and find that it does not match. The radio node may then transmit a signal (not shown) to the wireless device C, indicating that the process should be terminated, allowing the wireless device C to return to the sleep state. If, however, the radio node would mistakenly verify the first authentication response 712′, the radio node may transmit (with reference to block 708′ and corresponding step S208 of FIG. 2) a second authentication response 716′ to the wireless device C. At this stage, the wireless device C again goes through the process of verifying a LFSR sequence of the second authentication response. In case it does not match (with reference to block 810) its own LFSR sequence, the wireless device C may terminate (with reference to block 812) the process and return to sleep state (with reference to block 616).

The above example of wireless device C illustrates the robustness that the 4-way handshake verification process provides. Since three different LFSR sequences have to be verified until the wake-up process is performed, the risk of a verification process, initiated by an erroneously transmitted WUS, reaching the final state is low.

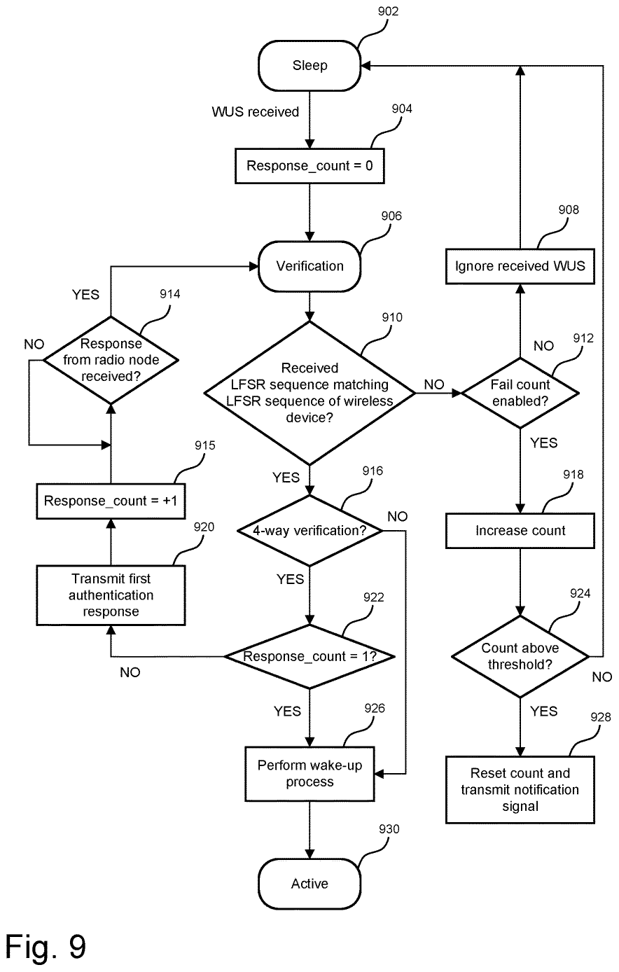

FIG. 9 is a flowchart illustrating some embodiments of a method performed in a wireless device. More specifically, the flowchart of FIG. 9 illustrates the functionality at the wireless device 300 covering the different aspects described in the forgoing in connection with FIGS. 1 to 8.

Starting from a sleep state (with reference to block 902), a wake-up signal (WUS) is received. A variable keeping track of a number of responses received, denoted Response_count is then set to 0 (with reference to block 904). The wireless device then transitions to a verification state (with reference to block 906). In the verification state, it is determined whether or not the received authentication pattern (i.e. a received first LFSR sequence) matches a verification pattern (i.e. a determined first LFSR sequence) of the wireless device (with reference to block 910).

If the authentication pattern matches the verification pattern, the method moves forward to block 916 where it is checked whether the 4-way handshake verification process is activated or not. If not, the method moves forward to block 926 where the wake-up process is performed. Then the wireless device is transformed into the active state (with reference to block 930). Whether the 4-way handshake verification process is activated or not may be specified in the configured set of rules. Put differently, the set of rules may comprise information about whether the 2 or 4-way handshake verification process should be used.

If the 4-way handshake verification process is activated (with reference to block 916), the method moves forward to block 922, in which it is checked whether the Response_count is equal to 1. If not, the method moves forward to block 920 where the first authentication response comprising a determined second LFSR sequence is transmitted to the radio node. In the next step, the Response_count is increased by one (with reference to block 915).

The method then moves forward to block 914 where the wireless device waits for a second authentication response from the radio node. A protection timer may be implemented in the wireless device such that if it has not received the second verification response within a certain time, the process may be terminated. Thus, it may be prevented that the wireless device gets stuck in a loop at block 914.

If the second authentication response is received at block 914, the method moves forward to block 906 where a received third LFSR sequence of the second authentication response is verified. The verification is made in block 910 where the received third LFSR sequence is compared to a determined third LFSR response, determined by the wireless device. If they match, the method moves forward through block 916 to block 922, where the Response_count now is equal to 1. The wake-up process of block 926 is then performed.

Moving back to block 910, if the LFSR sequences do not match, the method moves forward to block 912 where it is determined whether or not counting of a number of failed verification attempts are active or not. If not, the WUS (or the second authentication response) is ignored, and the wireless device transitions back to the sleep state (with reference to block 902).

If the count of failed verification attempts is active, the method moves forward to block 918 where the count of failed verification attempts is increased by one. Whether the count of failed verification attempts should be active or not may be comprised in the configured set of rules. If the count exceeds a threshold (with reference to block 924), the count may be reset, and the notification signal may be transmitted to the radio node (with reference to block 928). After the notification signal is transmitted, the wireless device may transition back to the sleep state (with reference to block 902) from the verification state. If the count is below the threshold in block 924, the wireless device transitions back to the sleep state. Even though not illustrated in FIG. 9, the wireless device 300 may perform the wake-up process in response to the count exceeding the threshold, and thus transition to the active state. In the active state, the wireless device may transmit the notification signal to the radio node. After transmitting the notification signal, the wireless device may transition back to the sleep state, from the active state.

As used throughout the present disclosure, the term “if” should be construed as “when” or “upon” or “in response to” or “in an instance of” or “in case of”.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

1.-30. (canceled)

31. A method performed in a wireless device, the method comprising:
receiving, from a radio node, a wake-up signal comprising an authentication pattern;
determining whether the authentication pattern matches a verification pattern of the wireless device, wherein the verification pattern is determined according to a configured set of rules in the wireless device; and
performing the following operations in response to a determination that the authentication pattern matches the verification pattern:
performing a wake-up process in the wireless device, and
transmitting an acknowledgement signal to the radio node.

32. The method according to claim 31, wherein:
the operations performed in response to a determination that that authentication pattern matches the verification pattern also include the following:
transmitting to the radio node a first authentication response, and
receiving from the second radio node a second authentication response; and
the wake-up process is performed in response to the second authentication response being verified by the wireless device.

33. The method according to claim 31, wherein:
the wake-up signal further comprises a target identification (ID);
the method further comprises determining whether the target ID matches or corresponds to a device ID of the wireless device; and
determining whether or not the authentication pattern matches a verification pattern of the wireless device is responsive to a determination that the target ID matches or corresponds to the device ID.

34. The method according to claim 33, wherein the target ID identifies one of the following: an individual wireless device, or a group of wireless devices.

35. The method according to claim 31, wherein:
the authentication pattern is determined according to a same set of rules as the configured set of rules used to determine the verification pattern; and
the set of rules is configured in the wireless device before the wake-up signal is received.

36. The method according to claim 31, wherein:
the wireless device comprises a first and second circuit, with the first circuit having a lower power consumption than the second circuit; and
receiving the wake-up signal and determining whether the authentication pattern matches the verification pattern is performed by the first circuit.

37. The method according to claim 36, wherein:
performing the wake-up process comprises transforming the wireless device from a first operating mode to a second operating mode;
the first circuit is operational in the first operating mode; and
the second circuit is operational in the second operating mode.

38. The method according to claim 31, further comprising:
in response to the authentication pattern not matching the verification pattern, increasing a count of failed verification attempts by one; and
in response to the count of failed verification attempts being above a threshold, transmitting a notification signal to the radio node.

39. The method according to claim 31, further comprising reconfiguring the set of rules according to one of the following: at a periodic time interval, or in response to occurrence of an event.

40. The method according to claim 31, wherein:
the verification pattern is a sequence generated by a Linear Feedback Shift Register; and
the configured set of rules defines the following: a sequence length of the verification pattern, a seed for the Linear Feedback Shift Register, and a location of taps in the Linear Feedback Shift Register.

41. A wireless device comprising control circuitry configured to:
receive, from a radio node, a wake-up signal comprising an authentication pattern;
determine whether the authentication pattern matches a verification pattern of the wireless device, wherein the verification pattern is determined according to a configured set of rules in the wireless device; and
perform the following operations in response to a determination that the authentication pattern matches the verification pattern:
perform a wake-up process in the wireless device, and
transmit an acknowledgement signal to the radio node.

42. A method performed in a radio node, the method comprising:
obtaining an authentication pattern determined according to a configured set of rules for a wireless device;
transmitting a wake-up signal to the wireless device, wherein the wake-up signal comprises the authentication pattern; and
receiving an acknowledgement signal from the wireless device, in response to the authentication pattern matching a verification pattern of the wireless device.

43. The method according to claim 42, further comprising:
receiving a first authentication response from the wireless device; and
based on verifying the first authentication response, transmitting a second verification response to the wireless device.

44. The method according to claim 42, wherein the wake-up signal further comprises a target identification (ID) of an intended wireless device.

45. The method according to claim 44, wherein the target ID identifies one of the following: an individual wireless device, or a group of wireless devices.

46. The method according to claim 42, wherein:
the verification pattern is determined according to a same set of rules as the configured set of rules used to determine the authentication pattern; and
the set of rules used to determine the verification pattern is configured in the wireless device before the wake-up signal is transmitted.

47. The method according to claim 42, further comprising, receiving from the radio node a notification signal indicating that a count of failed verification attempts by the wireless device is above a threshold.

48. The method according to claim 42, further comprising reconfiguring the set of rules according to one of the following: at a periodic time interval, or in response to occurrence of an event

49. The method according to claim 42, wherein:
the authentication pattern is a sequence generated by a Linear Feedback Shift Register; and
the configured set of rules defines the following: a sequence length of the authentication pattern, a seed for the Linear Feedback Shift Register, and a location of taps in the Linear Feedback Shift Register.

50. A radio node comprising control circuitry configured to perform the method of claim 42.
